(19) United States
(12) Patent Application Publication
(10) Pub. No.: US 2006/0026198 A1
(43) Pub. Date: Feb. 2, 2006

(54) Method and apparatus for synchronizing contact data stores

(75) Inventors: Jeffrey Kenneth Emery, Ottawa (CA); Ronald Scotte Zinn, Waterloo (CA); John Stuart Hodgson, Ottawa (CA)

Correspondence Address: MOFFAT & CO, 427 LAURIER AVEUE W., SUITE 1200, OTTAWA, ON, K1R 7Y2, CA

(73) Assignee: Research in Motion Ltd.

(21) Appl. No.: 11/117,410

(22) Filed: Apr. 29, 2005

Related U.S. Application Data
(60) Provisional application No. 60/592,132, filed on Jul. 30, 2004.

(51) Int. Cl. G06F 17/00

(52) U.S. Cl. 707/103 R

(57) ABSTRACT

A mobile device for synchronizing contact data stores comprising: a host having: a database for storing contact records; and a contact application communicating with the database and being capable of altering the contact records; a client having: a client contact application capable of altering the contact records; and a client data manager communicating with the client contact application for storing contact records; a state machine; a client listener to determine when a change has been made and propagate the change to the host; and a host listener to determine when a client record has been changed in the database and propagate the change to the client, wherein the database and the client data manager are synchronized through the state machine. Also, a method for synchronizing contact record storage by notification and propagation of changes through the state machine upon changes occurring in the database and client data manager.

### RELATED APPLICATIONS

The present application claims priority from U.S. provisional application Ser. No. 60/592,132 filed Jul. 30, 2004.

### FIELD OF THE APPLICATION

The present application deals with a method and apparatus for synchronizing contact data stores and, in particular, deals with the synchronization of address books on a mobile device with multiple address books.

### BACKGROUND

A hand-held device will often have an address book to provide a user with access to frequent contacts or as a manager for important contact information. This address book typically comprises an interface and an application interacting with the interface. The interface is used to add, delete, change or retrieve information. Data within the address book is typically stored in a database underlying the application.

A difficulty, however, occurs when two address books exist on one hand-held device. This could occur, for example, in situations in which a mobile device has the functionality of a data device added to it. In this case, when in the mobile device mode, a first address book may be accessible but when in the data device mode, a second address book may be accessible. It is desirable that the address book in each mode be the same, and changes made in one be propagated to the other.

Further difficulties occur when synchronizing one of the address books with an external address book. The multiple address books on the mobile device then also need to be synchronized.

### BRIEF DESCRIPTION OF THE DRAWINGS

The present application will be better understood with reference to the drawings in which:

FIG. 1 is a schematic diagram illustrating the various components and the flow of data according to the method and apparatus herein;

FIG. 2 is a schematic diagram illustrating an alternative embodiment of the various components and the flow of data according to the method and apparatus herein; and

FIG. 3 is a block diagram of a host mobile station in wireless communication with a communication network in accordance with at least one of the preferred embodiments.

### DETAILED DESCRIPTION OF THE DRAWINGS

The present application provides a method and apparatus for synchronizing contact data stores in a mobile device. Specifically, on a host device, which includes a host address book and a host database, a client is added which includes a client address book application and a client data manager for the client address book application. A state machine exists between the host and the data device that is used to keep the address books synchronized.

When a user makes a change in the host address book, such as adding, modifying or deleting a record, this information is sent directly to the host database. The state machine receives notification of this change in the host database and notifies the client data manager that a change has been made. The client data manager then requests from the host database the changed record and this is sent back to the client data manager, thereby synchronizing the client data manager with the host database.

If the user modifies the address book on the client side, this change in contact information is propagated through the state machine to the host database. The host database will then send a notification through the state machine to the client data manager on the client side. The client data manager then can then request a copy of the record, which it uses to update its own data, and thereby synchronize with the host database.

In one configuration, the data device can have its own client database that is kept synchronized with the host database through the client data manager.

In alternative embodiments, the client database can become the master database if the client database is synchronized with an external database. Such synchronization can occur, for example, when the mobile device is connected to a personal computer and can update its address book using an address book on the personal computer.

There is therefore provided a mobile device for synchronizing contact data stores comprising: a host, said host having: a database for storing contact records; and a contact application communicating with said database, said contact application being capable of altering said contact records; a client, said client having: a client contact application, said client contact application being capable of altering said contact records; and a client data manager communicating with said client contact application for storing contact records; a state machine for communicating between said client and said host; a client listener to determine when a change has been made at said client and propagate said change to said host through said state machine; and a host listener to determine when a client record has been changed in said database and propagate said change to said client, wherein said database and said client data manager are synchronized through said state machine.

There is further provided a method for synchronizing contact information in a handheld device having a first database, a client data manager, a first contact application communicating directly with said first database, a second contact application and a state machine, the method comprising the steps of: if contact information is altered at said first contact application sending altered contact information to said first database; receiving at said state machine notification of said altered contact information; notifying said client data manager of said altered contact information; receiving from client data manager a request for said altered contact information; and forwarding said altered contact information to said client data manager; and if said contact information is altered at said second contact application modifying said first database with said altered contact information; sending from said state machine to said client data manager a notification of said altered contact information; receiving at said state machine a request for said altered contact information; and forwarding said altered contact information from said first database to said client data manager.

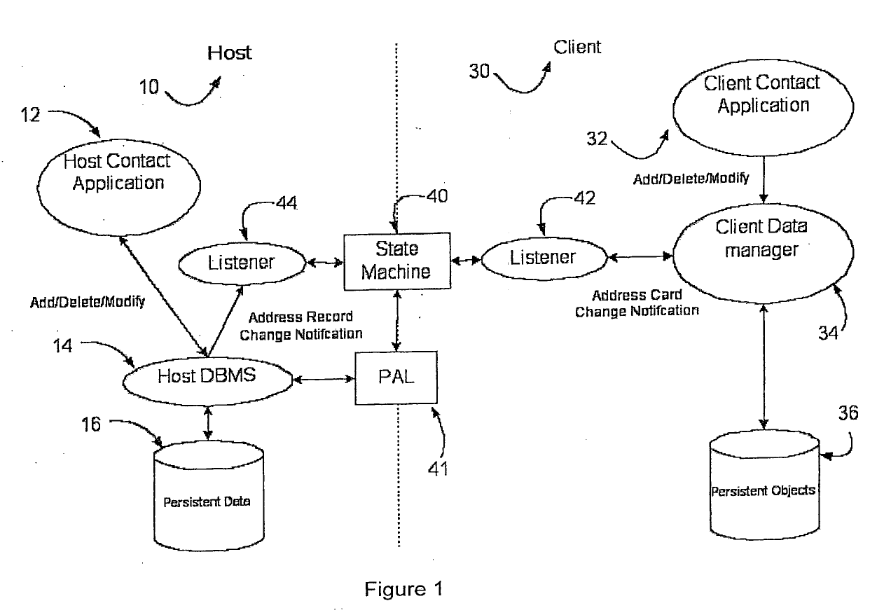

Reference is now made to FIG. 1. The present application includes a host for performing native functions and a client residing on the host machine for performing non-native functions. In one embodiment, the host system is a cellular telephone system and the client is a data device client. However, this is not meant to limit the scope of the present application and various hosts and clients would be apparent to those skilled in the art.

Host 10 includes a contact application 12 such as an address book application. Contact application 12 communicates directly with a host Database Management System (DBMS) 14. DBMS' 14 are well-known to those skilled in the art.

Host DBMS 14 communicates with a host database 16 which stores contact records.

Client 30 includes a client contact application 32 that communicates with client data manager 34. In one embodiment of the present application, client data manager 34 also communicates with a client database 36 to store information for client contact application 32.

As will be described in more detail below, in order for host contact application 12 to be synchronized with client contact application 32, the present system and method includes a state machine 40 for communications between the contact applications. State machine 40 includes a listener 42 to check when changes have been made to client contact application 32 and a listener 44 to check when changes have been made to host contact application 12. State machine 40 is used to send notifications and data between the contact applications to ensure they are synchronized.

Contact application 32 receives contact records from host database 16 using a processor application layer interface (PAL) 41. In one embodiment of the present system and method, the interface for host database 16 is asynchronous and implemented through message passing of handles. The processor application layer synchronizes database interactions originating from the client contact application 32 and further listens for changes made in database 16 from host contact application 12. A version of database 16 is maintained on a transaction basis, persisted and reflected in client contact application 32 within client data manager 34.

The processor application layer further provides a set of application interfaces to add, delete, modify and retrieve records from database 16. Interfaces also include other functions that would be known to those skilled in the art including accessing the number of records and the current version of database 16.

The present system and method therefore provide a device with two contact applications such as two address books, with the same central database as a repository for information. Both address books can be accessed and updated and therefore need to remain synchronized.

A typical transaction from the host side would occur as follows. A user alters a contact record using contact application 12. By altering, this could be the addition, deletion, or modification of a record. Once the contact record has been altered, contact application 12 modifies the contact record in database 16 using host DBMS 14.

Host DBMS 14 further notifies listener 44 of state machine 40 that the contact record has been altered, including sending a unique identifier for the record. Listener 44 communicates with stat machine (SM) 40 which notifies client data manager 34 that a record has changed. Client data manager 34 then requests from listener 42 a copy of the altered record. Listener 42 requests the altered record using the state machine 40., which gets the altered record through host DBMS 14 and host database 16. This altered record is then passed back through listener 44 and listener 42 to client data manager 34 where it is updated. Any subsequent access of this record by contact application 32 will reflect the altered record.

As one skilled in the art will appreciate, instead of passing a notification message, host DBMS 14 could instead pass the altered record which could be written directly to client data manager 34 in the above.

Similarly, if a contact is altered at the client contact application 32, this altered record is passed through client data manager 34, listener 42, state machine 40 to host DBMS 14 and ultimately to database 16. At this point, host DBMS 14 indicates to listener 44 that host database 16 has been modified. This notification is passed to state machine 40 The client data manager 34 can then be modified to reflect the contents of host database 16.

An altered record is first passed to host database 16 rather than being stored in client data manager 34 immediately in order to ensure that the unique identifier for the record is the same on both the client and host sides. Database 16 assigns the record a unique identifier, and this information is passed back to client data manager 34. The above ensures that when a new address or contact record is created the unique identifier for the record is the same in database 16 and client data manager 34.

In order to ensure validity and state machine tracking, it is preferable that all database functions be synchronous. In the case of an asynchronous interface for database access, a mutex (mutual exchange) can provide the synchronization mechanism. A shared memory area (not shown) can provide the data/status passing mechanism. A preferred synchronization scenario is as follows:
A. Contact application 32 calls a database application program interface (API) in the context of the virtual machine (VM) task.
B. The API sends a message to the OS task.
C. The OS task performs a “get” on a shared mutex without a waiting mechanism.
i. If the mutex is not available, the OS task sends an error message to the VM task via the shared memory mechanism.
D. The OS task prepares a message and sends it to host DBMS 14.
E. The VM task performs a “get” on the shared mutex and blocks with time-out.
i. If the mutex times out an error code is returned to client contact application 32.
F. The OS task receives the response from the host DBMS 14 and copies it into the shared memory area.
G. The OS task returns the mutex.
H. The VM task unblocks and returns the data to client contact application 32.

As will be appreciated by one skilled in the art, the above is one example of synchronization when information is being received from the host database 16. The blocking of messages until a response is received ensures synchronous communication between contact application 32 and host database 16 and thus ensures state machine tracking.

The processor application layer further includes a database interface. A handle is created using man machine interface (MMI) memory allocate and free functions. The handles is formatted using field specific calls and the database command sent to the host DBMS 14. The handle is destroyed at the termination of each call and all allocated memory freed.

If the fields in database 16 are different than those in client data manager 34, one skilled in the art will appreciate that mapping can occur between like fields. Further, database 16 and client data manager 34 can be expanded to include fields that are in one but not the other.

In order to ensure synchronization upon start-up, contact application 32 will check the version in host database 16. If the version in host database 16 matches the version known by client contact application 32, no updating will be done at the start-up of client contact application 32. Otherwise, if the versions do not match, client contact application 32 will remove all persistent address records from client data manager 34 and client data manager 34 will be updated with the records that are currently in host database 16.

Similarly, in an error situation in which, for example, state machine 40 times-out or is unable to process information, a synchronization error has occurred and therefore client data manager 34 is cleared and new data records are updated from database 16.

Various scenarios of utilizing the above are described below:

Add Contact Record from Host

When the host adds a contact record through contact application 12, listener 44 receives the event from the database host database manager 14 and increments the version of database 16. Listener 44 provides the contact record, including a long unique identifier and version to the listener 42. Listener 42 makes a call to add the contact record to the client contact application 32 and updates the data version.

Add Contact Record from Client

When the user adds an contact record from client contact application 32, the client contact application 32 calls the host to add the contact record to host database 16. Host database 16 returns with the correct long unique identifier, which is copied into the contact record and it is then added to the client data manager. Listener 44 will trap the add contact record event from the host database 16, update the version, send the new version to the listener 44 as an update version event.

Delete Contact Record from Host

When the host deletes a contact record listener 44 receives the event and increments the version. It provides the contact record long unique identifier and version to listener 42. Listener 42 makes a delete call to remove the contact record from the client contact application 32 and updates the client version.

Delete Contact Record from Client

When the user deletes an contact record from the client the client contact application deletes the contact record and calls the host to delete the contact record from host database 16. Listener 44 will trap the delete contact record event from host database 16, update the version, sends the new version to the listener 42 as an update version event.

Modify Contact Record from Host

When the host modifies a contact record listener 44 receives the event and increments the version. Listener 44 provide the contact record and version to listener 42. Listener 42 makes a modify call to update the contact record to client contact application 32 and updates the client version.

Modify Contact Record from Client

When the user modifies an contact record from the client the client contact application 32 modifies the contact record and calls the host to modify the contact record in host database 16. Listener 42 will trap the modify contact record event from host database 16, update the version and send the new version to the listener 42 as an update version event.

Start-Up

Client contact application 32 at start-up makes a call to get the version of host database 16. If the version number matches the version of the client no action is taken. If there is a mismatch the client contact application 32 performs a restore action.

Restore

Client contact application 32 on a restore deletes all contact record objects and associated ordered lists. It locks host database 16 and calls a function to get all the long unique identifiers from host database 16. It queries each contact record from host database 16 and adds them to its client data manager 34 with long unique identifiers.

Synch

Listener 44 receives a synch start message from host 10. Listener 44 disables event generation to listener 42. When a synch complete message is received host 10 initializes its version number and sends an update version event to the listener 42. This will trigger a restore action.

In one embodiment, the above is implemented on a mobile telephone. The client is a data device client using Java. The data device client, through the synchronized address book includes functionality such as email and phone support.

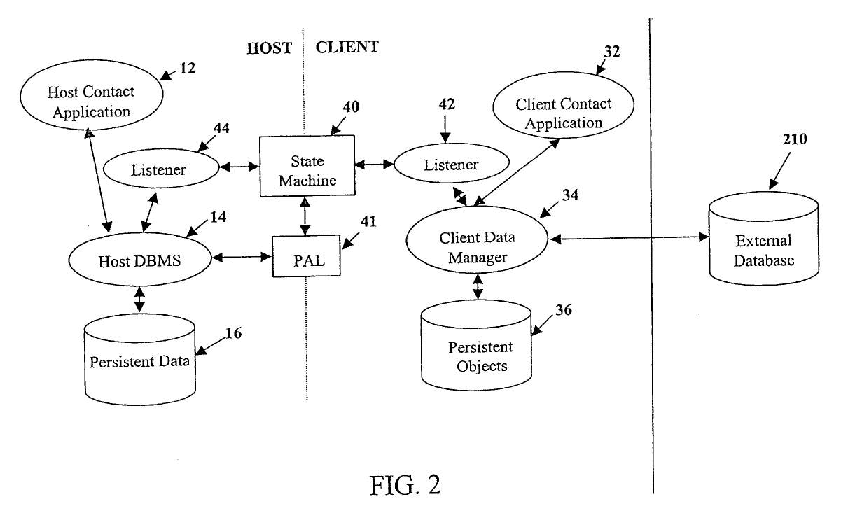

Reference is now made to FIG. 2. For clarity, numbers from FIG. 1 will be used in FIG. 2 when the objects referred to are similar. FIG. 2 illustrates an alternative embodiment in which synchronization is required between the persistent objects database 36 and an external database. As will be appreciated by one skilled in the art, the mobile device can communicate with an external database 210 using various means, including a serial connection, short range wireless communication or wireless radio frequency communications, among others.

If a user wants the objects in the persistent objects database 36 to be synchronized with external database 210, persistent objects database 36 needs to become the master database with respect to host database 16. Client database 36 is preferably adapted to synchronize with external database 210, wherein host database 16 may not be.

In a preferred embodiment, switching client database 36 to become the master database can be accomplished with a software marker such as a variable. This variable is called WIRELESS SYNCH herein, and if WIRELESS SYNCH is set to true then client database 36 becomes the master database. Based on this, client data manager 34 monitors client database 36 and when client database 36 is changed, client data manager 34 notifies listener 42 of the change. Listener 42 communicates with the state machine 40 and listener 44, which then through host DBMS 14 requests the new record from client data manager 34 using listeners 42 and 44 and state machine 40. Thus synchronization of the databases on the mobile device occurs to client database 36 rather than to host database 16 as described above.

In one embodiment, external synchronization occurs through a wireless network. An external server communicates through a data network with a personal computer. Personal computer includes an external database 210 to which the mobile station wants to synchronize. The server can further store a copy of external database.

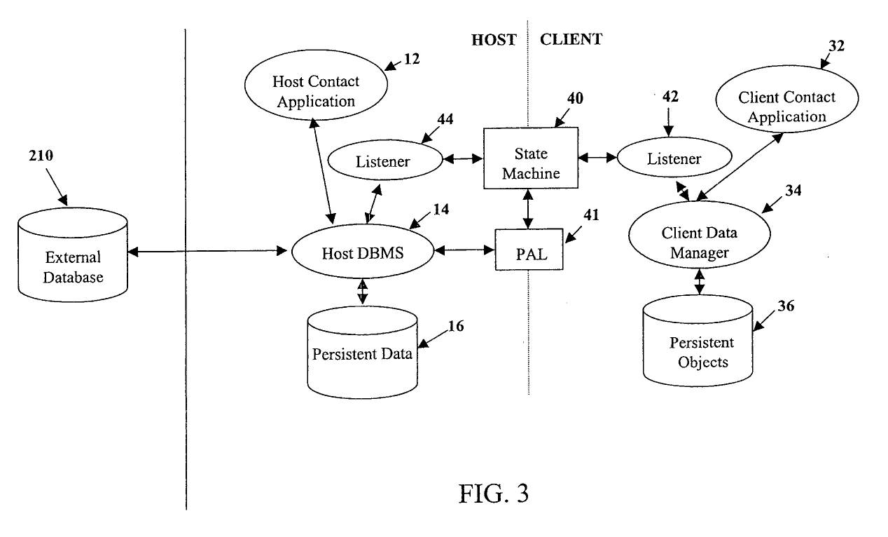

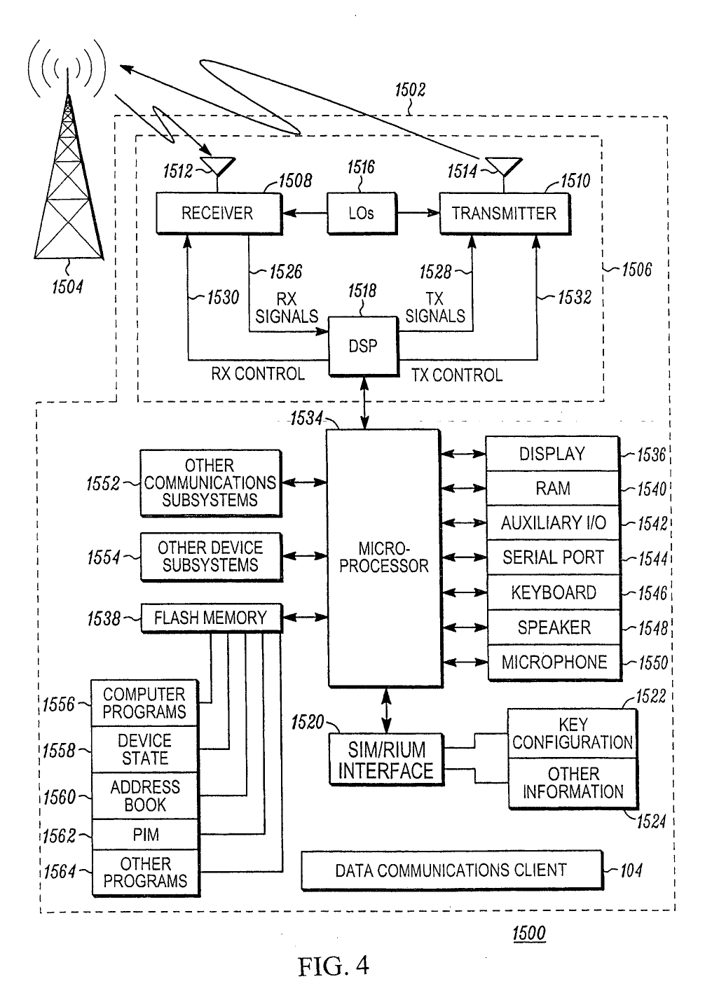

The server communicates with the mobile device through a wireless network, as described in more detail below with regard to FIG. 3. When a user wants to synchronize a database such as an address book on the mobile station with the database 210 on the personal computer, a message can be sent from the mobile station requesting synchronization. In other embodiments the synchronization request could come from the personal computer, when, for example, records in database 210 have been changed.

Reference is now made to FIG. 3. FIG. 3 is a block diagram 1500 of a host mobile station 1502 in wireless communication with a communication network 1504 in accordance with a preferred embodiments. The host mobile station 1502 is preferably a two-way wireless communication device having at least voice and data communication capabilities, and preferably also has the capability to communicate with other computer systems on the Internet. Depending on the exact functionality provided, the host mobile station 1502 may be referred to as a data messaging device, a two-way pager, a wireless e-mail device, a cellular telephone with data messaging capabilities, a wireless Internet appliance, or a data communication device, as examples.

Where the host mobile station 1502 is enabled for two-way communication, it will incorporate a communication subsystem 1506, including both a receiver 1508 and a transmitter 1510, as well as associated components such as one or more, preferably embedded or internal, a receiver antenna 1512 and a transmitter antenna 1514, local oscillators (“LO”s) 1516, and a processing module such as a digital signal processor (“DSP”) 1518. As will be apparent to those skilled in the field of communications, the particular design of the communication subsystem 1506 will be dependent upon the communication network in which the device is intended to operate. For example, host mobile station 1502 may include the communication subsystem 1506 designed to operate within the Mobitex™ mobile communication system, the DataTAC™ mobile communication system, General Packet Radio Service (“GPRS”) network, Universal Mobile Telecommunications System (“UMTS”) network, Enhanced Data for Global System for Mobile Communications (“GSM”) Evolution (“EDGE”) network or Code Division Multiple Access (“CDMA”) network.

Network access requirements will also vary depending upon the type of network 1504. For example, in the Mobitex and DataTAC networks, the host mobile station 1502 is registered on the communication network 1504 using a unique identification number associated with each mobile station. In UMTS and GPRS networks, and in some CDMA networks, however, network access is associated with a subscriber or user of the host mobile station 1502. A GPRS mobile station therefore requires a subscriber identity module (“SIM”) card in order to operate on a GPRS network, and a Removable User Identity Module (“RUIM”) in order to operate on some CDMA networks. Although the host mobile station 1502 would not fully function without a valid SIM/RUIM card if it is a GPRS/UMTS/CDMA mobile station, local or non-network communication functions, as well as legally required functions (if any) such as “911” emergency calling, may still be available. However, the host mobile station 1502 will be unable to carry out any other functions involving communications over the communication network 1504. A SIM/RUIM interface 1520, which is configured to accept a SIM/RUIM card, is normally similar to a card-slot into which the SIM/RUIM card can be inserted and ejected like a diskette or a Personal Computer Memory Card International Association (“PCMCIA”) card. The SIM/RUIM card can have approximately 64K of memory and hold many key configuration 1522, and other information 1524 such as identification, and subscriber related information.

When required network registration or activation procedures have been completed, the host mobile station 1502 may send and receive communication signals over the communication network 1504. Signals received by the receiver antenna 1512 from the communication network 1504 are input to the receiver 1508, which may perform such common receiver functions as signal amplification, frequency down conversion, filtering, channel selection and the like, and in the example system shown in FIG. 3, analog to digital (“A/D”) conversion. A/D conversion of a received signal allows more complex communication functions such as demodulation and decoding to be performed in the DSP 1518. In a similar manner, signals to be transmitted are processed, including modulation and encoding for example, by the DSP 1518 and input to the transmitter 1510 for digital to analog (“D/A”)conversion, frequency up conversion, filtering, amplification and transmission over the communication network 1504 via the transmit antenna 1514. The DSP 1518, in addition to processing receive and transmit communication signals 1526 and 1528, provides for receiver and transmitter controls 1530 and 1532. For example, the gains applied to communication signals in the receiver 1508 and the transmitter 1510 may be adaptively controlled through automatic gain control algorithms implemented in the DSP 1518.

The communication network 1504 may further communicate with multiple systems (not shown). For example, the communication network 1504 may communicate with both an enterprise system and a web client system in order to accommodate various clients with various service levels.

The host mobile station 1502 preferably includes a microprocessor 1534, which controls the overall operation of the host mobile station 1502. Communication functions, including at least data and voice communications, are performed through the communication subsystem 1506. The microprocessor 1534 also interacts with further device subsystems such as flash memory 1536, a display 1538, random access memory.(“RAM”) 1540, auxiliary input/output (I/O) subsystems 1542, a serial port 1544, a keyboard 1546, a speaker 1548, a microphone 1550, other communications subsystem 1552, and any other compatible device subsystems, which is generally designated as 1554. Some of the subsystems shown in FIG. 15 perform communication-related functions, whereas other subsystems may provide “resident” or on-device functions. Notably, some subsystems, such as the keyboard 1546 and the display 1538, for example, may be used for both communication-related functions, such as entering a text message for transmission over a communication network, and device-resident functions such as a calculator or task list.

Operating system software used by the microprocessor 1534 is preferably stored in a persistent store such as the flash memory 1538, which may instead be a read-only memory (“ROM”) or similar storage element (not shown). Those skilled in the art will appreciate that the operating system, specific device applications, or parts thereof, may be temporarily loaded into a volatile memory such as the RAM 1540. Received communication signals may also be stored in the RAM 1540.

As shown in FIG. 3, the flash memory 1536 can be segregated into different areas for both computer programs 1556 and program data storage such as device state 1558, an address book 1560, personal information manager (“PIM”) 1562, and other programs 1564. These different storage types indicate that each program can allocate a portion of the flash memory 1536 for their own data storage requirements. The microprocessor 1534, in addition to its operating system functions, preferably enables execution of software applications on the host mobile station 1502. A predetermined set of applications that control basic operations, including at least data and voice communication applications for example, will normally be installed on the host mobile station 1502 during manufacturing. A preferred software application may be a PIM application having the ability to organize and manage data items relating to the user of the host mobile station 1502 such as, but not limited to, e-mail, calendar events, voice mails, appointments, and task items. Naturally, one or more memory stores would be available on the host mobile station 1502 to facilitate storage of PIM data items. Such PIM application would preferably have the ability to send and receive data items, via the communication network 1504. In a preferred embodiment, the PIM data items are seamlessly integrated, synchronized and updated, via the communication network 1504, with the host mobile station user's corresponding data items stored or associated with a host computer system. Additional applications may also be loaded onto the host mobile station 1502 through the communication network 1504, the auxiliary I/O subsystem 1543, the serial port 1544, other communications subsystem 1552 or any other compatible device subsystem 1554, and be installed by the user in the RAM 1540 or preferably a non-volatile store (not shown) for execution by the microprocessor 1534. Such flexibility in application installation increases the functionality of the host mobile station 1502 and may provide enhanced on-device functions, communication-related functions, or both. For example, secure communication applications may enable electronic commerce functions and other such financial transactions to be performed using the host mobile station 1502.

In a data communication mode, a received signal such as a text message or web page download will be processed by the communication subsystem 1506 and input to the microprocessor 1534, which preferably further processes the received signal for output to the display 1538, or alternatively to the auxiliary I/O subsystems 1542. The user of the host mobile station 1502 may also compose data items such as e-mail messages for example, using the keyboard 1546, which is preferably a complete alphanumeric keyboard or telephone-type keypad, in conjunction with the display 1538 and possibly with the auxiliary I/O subsystems 1542. Such composed items may then be transmitted over the communication network 1504 through the communication subsystem 1506.

For voice communications, overall operation of the host mobile station 1502 is similar, except that the received signals would preferably be output to the speaker 1548 and signals for transmission would be generated by the microphone 1550. Alternative voice or audio I/O subsystems, such as a voice message recording subsystem, may also be implemented on the host mobile station 1502. Although voice or audio signal output is preferably accomplished primarily through the speaker 1548, the display 1538 may also be used to provide an indication of the identity of a calling party, the duration of a voice call, or other voice call related information for example.

The serial port 1544, such as Universal Serial Bus (“USB”), in FIG. 3 would normally be implemented in a personal digital assistant (“PDA”)-type host mobile station for which synchronization with a user's desktop computer (not shown) may be desirable, but is an optional device component. The serial port 1544 would enable the user to set preferences through an external device or software application and would extend the capabilities of the host mobile station 1502 by providing for information or software downloads to host mobile station 1502 other than through a wireless communication network. An alternate download path may for example be used to load an encryption key onto the device through a direct and thus reliable and trusted connection to thereby enable secure device communication. Other communications subsystems 1552, such as a short-range communications subsystem, is a further optional component which may provide for communication between the host mobile station 1502 and different systems or devices, which need not necessarily be similar devices. For example, the other communications subsystem 1552 may include an infrared device and associated circuits and components or a Bluetooth™ communication module to provide for communication with similarly enabled systems and devices.

A mobile communications device, such as a cellular telephone, is typically formed of software, firmware, and hardware adapted to provide communications services over a compatible wireless communications network. This process of forming the relationship between the mobile communications device and the service is known in the art as provisioning. Typically, a network operator provisions the mobile communications device via a subscription to a service contract. Thus, once the mobile communications device has been provisioned, the user of the mobile communications device is often referred to as a subscriber. In a voice and data network such as GSM, GPRS, CDMA, or various other third generation networks such as EDGE or UMTS, both voice and data services may be available to mobile communications devices. Such voice services include voice calling and SMS, and such data services include Internet browsing, email, and MMS.

Although many services may be available on a given network, only those subscribers who use mobile communications devices that have been provisioned for those services will be able to benefit from them. This limitation may present problems for both the subscriber and the network operator. On one hand, the subscriber may desire an existing service he does not have, i.e. an upgrade, or desire disabling a service, i.e. a downgrade. On the other hand the operator may want to offer a new service, but may hesitate if subscribers cannot benefit from them. One known solution is to provide an out of band communications link, such as a Universal Serial Bus (“USB”), on the mobile communications device, and enable the subscriber to load new software onto the mobile communications device via the out of band communication link using a personal computer, thus re-provisioning the mobile communications device. This solution may be an unacceptable solution to both the subscriber and the operator as there is a significant risk that the mobile communications device, by error, receives a wrong or incomplete load, and may require servicing. Furthermore, this solution may be unacceptable to the subscriber who does not have access to a personal computer. However, because the host mobile station 1502 is a host communications device that hosts a data communications client, the data communications client may be provisioned directly by the user of host mobile station 1502.

The above-described embodiments are meant to be illustrative of preferred embodiments and are not intended to limit the scope of the present application. Also, various modifications, which would be readily apparent to one skilled in the art, are intended to be within the scope of the present application. The only limitations to the scope of the present application are set forth in the following claims.

We claim:

1. A mobile device for synchronizing contact data stores comprising:
a) a host, said host having:
i. a database for storing contact records; and
ii. a contact application communicating with said database, said contact application being capable of altering said contact records;
b) a client, said client having:
i. a client contact application, said client contact application being capable of altering said contact records; and
ii. a client data manager communicating with said client contact application for storing contact records;
c) a state machine for communicating between said client and said host;
d) a client listener to determine when a change has been made at said client and propagate said change to said host through said state machine; and
e) a host listener to determine when a client record has been changed in said database and propagate said change to said client,
wherein said database and said client data manager are synchronized through said state machine.

2. The mobile device of claim 1 further comprising a database management system between said contact application and said database.

3. The mobile device of claim 2 further comprising a client database communicating with said client data manager and maintaining synchronized contact records with said database in said host.

4. The mobile device of claim 1, wherein altering said contact records includes adding a new contact record, deleting and existing contact record or modifying an existing contact record.

5. The mobile device of claim 1, further comprising a communications system for communicating with an external database.

6. The mobile device of claim 5, wherein the mobile device further includes memory for storing a variable, said variable indicating whether said mobile device is enabled to synchronize with said external database.

7. The mobile device of claim 6, wherein the client database becomes a master database when said variable indicates that said mobile device is enabled to synchronize with said external database.

8. A method for synchronizing contact data stores in a mobile device having a host database and a client database, the method comprising:
a) designating one of the host database and client database a master database and the other of the host database and client database as a slave database;
b) configuring a listening application to monitor the master database;
c) if the master database changes, sending a message from the listening application, through a state machine, to the slave database with the change in the master database;
d) setting a data manager to monitor the slave database; and
e) if the data manager detects a change request for the slave database, sending a change message to the master database.

9. The method of claim 8, wherein said designating step is determined based on a variable set at the mobile device.

10. The method of claim 9, wherein the variable designates that the mobile device can synchronize with an external database.

11. The method of claim 10, wherein the client database becomes the master database if the variable designates the mobile device can synchronize with an external database.

12. The method of claim 8, wherein the host and client databases are address books.

13. The method of claim 12, wherein changes to the host and client databases originate at a contact application.

14. The method of claim 10, further comprising the step of synchronizing the client database with the external database.
